(19) United States
(12) Patent Application Publication
(10) Pub. No.: US 2013/0148247 A1
(43) Pub. Date: Jun. 13, 2013

(54) OVERVOLTAGE PROTECTION CIRCUIT

(71) Applicants: HAI-QING ZHOU, Shenzhen City (CN); JIN-LIANG XIONG, Shenzhen City (CN); YI-XIN TU, Shenzhen City (CN)

(72) Inventors: HAI-QING ZHOU, Shenzhen City (CN); JIN-LIANG XIONG, Shenzhen City (CN); YI-XIN TU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/600,108

(22) Filed: Aug. 30, 2012

(30) Foreign Application Priority Data
Dec. 12, 2011 (CN) 201110410669.4

(51) Int. Cl. H02H 3/20

(52) U.S. Cl. 361/91.5; 361/91.1

(57) ABSTRACT

An overvoltage protection circuit includes a power device for outputting a plurality of first powers, a plurality of VRMs for respectively receiving the plurality of first powers, a plurality of voltage dividing circuits, a reference power supply for outputting a reference voltage, and a comparison circuit having a comparator. Each VRM converts a corresponding first power to a regulated second power. The plurality of voltage dividing circuits respectively divides voltages of the second powers, each voltage dividing circuit outputs a divided voltage. The comparator compares a combination of the divided voltages with the reference voltage, and when an overvoltage occurs in at least one of the second powers, the comparator outputs a control signal via the output terminal to the power device to control the power device to shut down all of the first powers.

### BACKGROUND

1. Technical Field

The exemplary disclosure generally relates to overvoltage protection circuits, and particularly to an overvoltage protection circuit for protecting voltage regulator modules (VRMs).

2. Description of Related Art

Computers usually have an advanced technology extended (ATX) power supply and a plurality of VRMs to power the electronic components of the mother board. The ATX power supply converts a commercial power (that is an alternating current voltage (A/C)) into a plurality of direct current (D/C)voltages, such as 3.3V, 5V, and 12V voltages, for example. The VRMs respectively convert these DC voltages to desired voltages to power corresponding electronic components of the motherboard. In order to prevent the VRMs from overvoltage, the motherboard usually has a plurality of overvoltage protection circuits each protecting a corresponding VRM. However, the aforementioned arrangement of the overvoltage protection circuits may add complexity to the motherboard and increase in an overall area of the motherboard.

Therefore, there is room for improvement within the art.

### BRIEF DESCRIPTION OF THE DRAWINGS

Many aspects of the embodiments can be better understood with reference to the drawings. In the drawings, the emphasis is placed upon clearly illustrating the principles of the disclosure.

FIG. 1 is a block diagram of an exemplary embodiment of an overvoltage protection circuit.

FIG. 2 is a schematic circuit diagram of the overvoltage protection circuit shown in FIG. 1.

### DETAILED DESCRIPTION

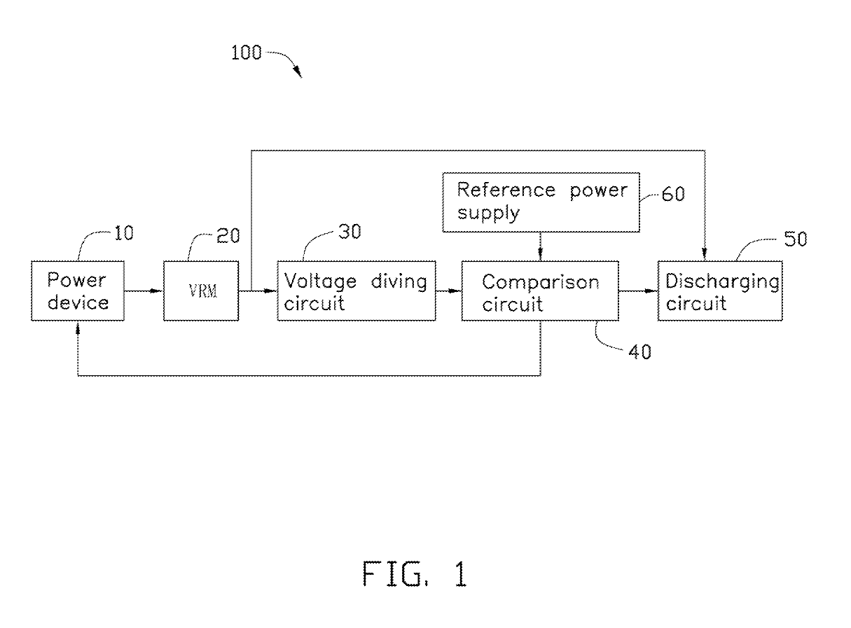

FIG. 1 is a block diagram of an exemplary embodiment of an overvoltage protection circuit. The overvoltage protection circuit 100 includes a power device 10, a plurality of VRMs 20, a plurality of voltage dividing circuits 30, a comparison circuit 40, a discharging circuit 50, and a reference power supply 60. The power device 10 are electronically connected to the VRMs 20 and the comparison circuit 40. The voltage dividing circuits 30 are electronically connected to the comparison circuit 40, and are respectively electronically connected to the VRMs 20. The discharging circuit 50 is electronically connected to the VRMs 20 and the comparison circuit 40.

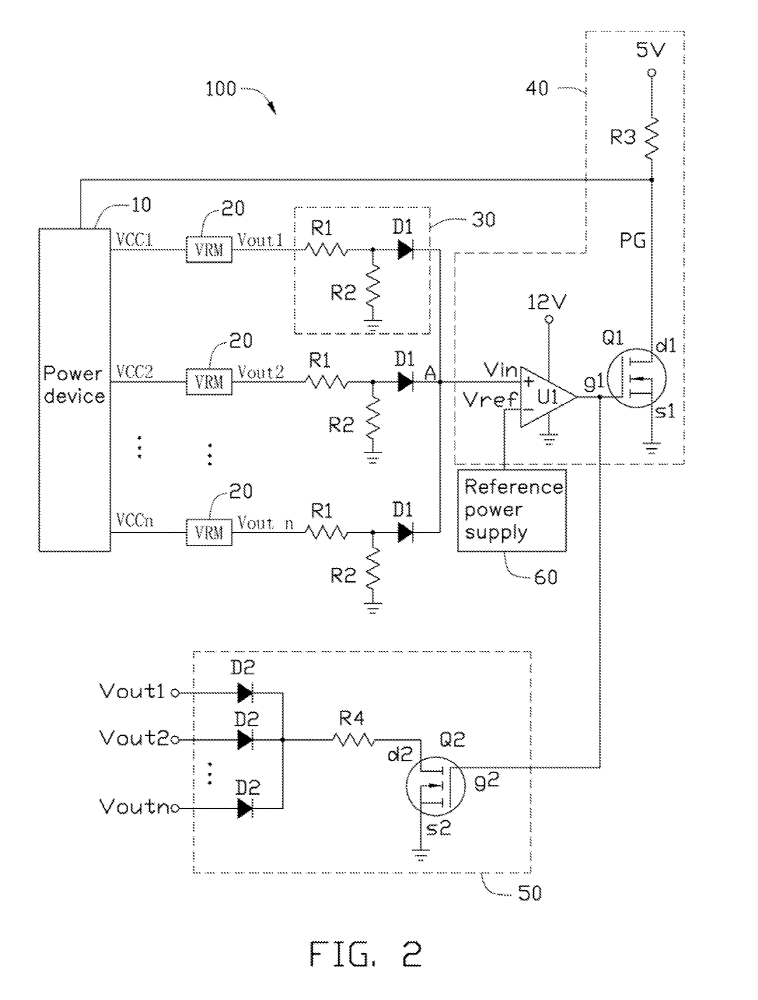

FIG. 2 is a schematic circuit diagram of the overvoltage protection circuit 100 shown in FIG. 1. The power device 10 converts an alternative source power received by a plug (not shown) to a plurality of direct first powers VCC1-VCCn, which are output to the VRMs 20 respectively. The first powers VCC1-VCCn can be 3.3V, 5V, 12V, and 24V respectively, for example. The power device 10 stops outputting the first powers VCC1-VCCn under the control of the comparison circuit 40. In one embodiment, the power device 10 is an ATX power supply.

The VRMs 20 respectively convert the corresponding first powers VCC1-VCCn to second powers Vout1-Vout n. Each second power Vout1-Vout n powers a load (not shown).

The comparison circuit 40 includes a comparator U1 comprising a non-inverting input terminal, an inverting input terminal, an output terminal, a positive power terminal, and a negative power terminal Each voltage dividing circuit 30 is electronically connected between a corresponding VRM 20 and the non-inverting input terminal of comparator U1. That is, the non-inverting input terminal is electronically connected to a common output node of the voltage dividing circuits 30. In the exemplary embodiment, the common output node is labeled as A. The voltage dividing circuits 30 respectively divide voltages of the second powers Vout1-Vout n, and then output the divided voltages to the non-inverting input terminal of the comparator U1. In other words, the voltage of the non-inverting input terminal of the comparator U1 is a combination of the divided voltages output from the voltage dividing circuit 30.

Each voltage dividing circuit 30 includes a first isolation diode D1, a first voltage dividing resistor R1, and a second voltage dividing resistor R2 connected in series to the first voltage dividing resistor R1. The first voltage dividing resistor R1 is electronically connected to an output terminal of a corresponding VRM 20. The second voltage dividing resistor R2 is grounded. An anode of the first isolation diode D1 is electronically connected to the node between the first and second voltage dividing resistors R1 and R2, a cathode of the first isolation diode D1 is electronically connected to the non-inverting input terminal of the comparator U1. A node between the first isolation diodes D1 of the voltage dividing circuits 30 is the common output node A. Each first isolation diode D1 is configured for preventing the corresponding second power Vout from being influenced by the other outputs Vout. For example, the first isolation diode D1 is arranged in a current path of the second power Vout1 is configured for preventing currents output from the other second powers Vout2-Vout n from flowing to the second power Vout1 via the common output node A, to influence an electric potential of the second power Vout1.

The inverting input terminal of the comparator U1 is electronically connected to the reference power supply 60. The positive power terminal of the comparator U1 is electronically connected to a power supply, such as a +12 power supply, to obtain power. The negative power terminal of the comparator U1 is grounded. The voltage of the non-inverting input terminal of the comparator U1, that is, the voltage of the common output node A is set as Vin, and a reference voltage output from the reference power supply 60 is set as Vref, that is, a voltage of the inverting input terminal of the comparator U1 is Vref. The resistances of the first and second voltage dividing resistors R1 and R2 are adjusted to ensure that when all of the second powers Vout1-Vout n are within their rated voltage respectively, the voltage Vin is lower than the voltage Vref, the comparator outputs a low level voltage signal (e.g. logic 0); and when at least one of the second powers Vout1-Vout n is greater than the upper tolerance limit of its rated voltage, that is, at least one overvoltage occurs, the voltage Vin is higher than the voltage Vref, the comparator outputs a high level voltage signal(e.g. logic 1).

The comparison circuit 40 further includes a first electronic switch Q1 configured for inverting levels of the output signals of the comparator U1 output to the power device 10. In one embodiment, the first electronic switch Q1 is an N-channel Metal-Oxide-Semiconductor Field-Effect Transistor (MOSFET), a gate g1 of the N-channel MOSFET Q1 is electronically connected to the output terminal of the comparator U1, a source s1 of the N-channel MOSFET Q1 is grounded, and a drain d1 of the N-channel MOSFET Q1 is electronically connected to a power supply, such as a +5V power supply via a first current limiting resistor R3. The drain d1 of the N-channel MOSFET Q1 is further electronically connected to the power device 10, and is configured for outputting a control signal PG to the power device 10 according to a comparison result of the comparator U1. When voltages of all of the second powers Vout1-Vout n are within their rated voltage range, the comparator U1 outputs a low level voltage signal, to switch off the first electronic switch Q1. At this time, the control signal PG is a high level voltage signal, the power device 10 keeps on outputting the first powers VCC1-VCCn. Alternatively, when the voltage of at least one of the second powers Vout1-Vout n is greater than the upper tolerance limit of its rated voltage, the comparator U1 outputs a high level voltage signal, to switch on the first electronic switch Q1. At this time, the control signal PG is a low level voltage signal, the power device 10 stops outputting all of the first powers VCC1-VCCn. Accordingly, the second powers Vout1-Vout n are shut down to prevent the connected loads from being destroyed.

It is to be understood that, in another embodiment, the first electronic switch Q1 can be an NPN type bipolar junction transistor (BJT), of which the base, the emitter and the collector have electronic connections to peripheral circuits respectively corresponding to the gate g1, the source s1 and the drain d1 of the N-channel MOSFET.

The discharging circuit 50 is configured for promptly releasing residual power of the second powers Vout1-Vout n output from the VRMs 20 when the first powers VCC1-VCCn are shut down. The discharging circuit 50 includes a second electronic switch Q2, a second current limiting resistor R4, and a plurality of second isolation diodes D2 equal in number to the number of the second powers Vout1-Vout n. In one embodiment, the second electronic switch Q2 is an N-channel MOSFET. A gate g2 of the N-channel MOSFET Q2 is electronically connected to the output terminal of the comparator U2. A source s2 of the N-channel MOSFET Q2 is grounded, and a drain d2 of the N-channel MOSFET Q2 is electronically connected to a cathode of each of the second isolation diodes D2 via the second current limiting resistor R4. An anode of each of the second isolation diodes D2 is electronically connected to a corresponding VRM 20. When at least one second powers Vout1-Vout n occurs overvoltage, the comparator U1 outputs a high level voltage signal, to stop the power device 10 from outputting the first powers VCC1-VCCn. Simultaneously, the second electronic switch Q2 switches on, the second powers Vout1-Vout n discharge via the second isolation diodes D2 and the second electronic switch Q2. The second isolation diodes D2 are configured for preventing the second powers Vout1-Vout n from being influenced by each other. In another embodiment, the second electronic switch Q2 can be an NPN type BJT, of which the base, the emitter and the collector have electronic connections to peripheral circuits respectively corresponding to the gate g2, the source s2 and the drain d2 of the N-channel MOSFET.

A combination of the divided voltages of the voltage dividing circuits 30 is compared with the reference voltage Vref by the comparator U1, when an overvoltage occurs in any one of the VRMs 20, the comparator U1 outputs the control signal PG to control the power device 10 to shut down the first powers VCC1-VCCn. Therefore, the plurality of VRMs 20 can share one overvoltage protection circuit 100, and the overall area of the mother board is relatively decreased.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An overvoltage protection circuit, comprising:
a power device configured for outputting a plurality of first powers;
a plurality of voltage regulator modules (VRMs) configured for respectively receiving the plurality of first powers, each VRM regulating a corresponding first power and outputting a regulated second power;
a plurality of voltage dividing circuits configured for respectively dividing voltages of the second powers, each voltage dividing circuit outputting a divided voltage;
a reference power supply configured for outputting a reference voltage; and
a comparison circuit comprising a comparator, a first input terminal of the comparator electronically connected to the reference power supply to obtain the reference voltage, a second input terminal of the comparator electronically connected to a common output node of the voltage dividing circuits, and an output terminal of the comparator electronically connected to the power device;
wherein the comparator compares a voltage of the common output node with the reference voltage; when an overvoltage occurs in at least one of the second powers, the comparator outputs a control signal via the output terminal to the power device to control the power device to shut down all of the first powers.

2. The overvoltage protection circuit of claim 1, wherein each voltage dividing circuit comprises a first isolation diode, a first voltage dividing resistor, and a second voltage dividing resistor electronically connected to the first voltage dividing resistor in series, the first voltage dividing resistor is electronically connected to a corresponding VRM, the second voltage dividing resistor is grounded, an anode of the first isolation diode is electronically connected to a node between the first and second voltage dividing resistors, and a cathode of the first isolation diode is electronically connected to the second input terminal of the comparator, a node between the second input terminal and the cathodes of the first isolation diodes of the voltage dividing circuits is the common output node.

3. The overvoltage protection circuit of claim 2, wherein the comparator outputs a low level when voltages of the second powers are respectively within rated voltages of the second powers; and the comparator outputs a high level when the voltage of at least one of the second powers is greater than the upper tolerance limit of the rated voltage.

4. The overvoltage protection circuit of claim 3, wherein the comparison circuit further comprises a first electronic switch and a first current limiting resistor, the first electronic switch is electronically connected to power supply via the first current limiting resistor, and is electronically connected to the output terminal of the comparator, a node between the electronic switch and the first current limiting resistor is electronically connected to the power device, when at least one of the second powers occurs overvoltage, the comparator controls the first electronic switch to switch on, and the node of the first electronic switch outputs a low level voltage to the power device to control the power device to shut down all of the first powers.

5. The overvoltage protection circuit of claim 4, wherein the first electronic device is a first N-channel Metal-Oxide-Semiconductor Field-Effect Transistor (MOSFET), a gate of the first N-channel MOSFET is electronically connected to the output terminal of the comparator, a source of the first N-channel MOSFET is grounded, and a drain of the first N-channel MOSFET is electronically connected to the power supply via the first current limiting resistor, a node between the drain and the first current limiting resistor is electronically connected to the power device.

6. The overvoltage protection circuit of claim 4, wherein the first electronic device is a first NPN type bipolar junction transistor (BJT), a base of the first NPN type BJT is electronically connected to the output terminal of the comparator, an emitter of the first NPN type BJT is grounded, and a collector of the first NPN type BJT is electronically connected to the power supply via the first current limiting resistor, a node between the collector and the first current limiting resistor is electronically connected to the power device.

7. The overvoltage protection circuit of claim 3, further comprising a discharging circuit, which comprises a second electronic switch electronically connected to the output terminal of the comparator, the plurality of second powers is grounded via the second electronic switch, when the comparator outputs a high level voltage, the second electronic switch switches on to allow the second powers to discharge via ground.

8. The overvoltage protection circuit of claim 7, wherein the second electronic switch is a second N-channel MOSFET, a gate of the second N-channel MOSFET is electronically connected to the output terminal of the comparator, a source of the second N-channel MOSFET is grounded, and a drain of the second N-channel MOSFET is electronically connected the VRMs.

9. The overvoltage protection circuit of claim 7, wherein the second electronic switch is a second NPN type BJT, a base of the second NPN type BJT is electronically connected to the output terminal of the comparator, a emitter of the second NPN type BJT is grounded, and a collector of the second NPN type BJT is electronically connected the VRMs.

10. The overvoltage protection circuit of claim 7, wherein the discharging circuit further comprises a plurality of second isolation diode, a cathode of each isolation diode is electronically connected to the second electronic switch, an anode of each isolation diode is electronically connected to a corresponding VRM.
